(19) United States
(12) Patent Application Publication
(10) Pub. No.: US 2004/0245334 A1
(43) Pub. Date: Dec. 9, 2004

(54) Inverted terminal presentation scanner and holder

(76) Inventor: Steven Maurice Sikorski, Warren, MI (US)

Correspondence Address: AMIN & TUROCY, LLP, 1900 EAST 9TH STREET, NATIONAL CITY CENTER, 24TH FLOOR,, CLEVELAND, OH, 44114, US

(21) Appl. No.: 10/748,992

(22) Filed: Dec. 29, 2003

Related U.S. Application Data
(60) Provisional application No. 60/476,702, filed on Jun. 6, 2003.

(51) Int. Cl. G06K 7/00; G06K 9/36; G06K 9/32; G06K 9/22

(52) U.S. Cl. 235/383; 235/436; 382/313; 382/291; 382/296; 235/482

(57) ABSTRACT

Systems and methodologies that facilitate data capture and/or display of data to users are provided. In one aspect, a mobile scanning terminal device provides inverting and/or rotating the display based at least upon; a user's perspective, image capture and bar code scanning requirements. Suitable orientation for the display can be determined via employing various sensors and artificial intelligence techniques to infer a user's optical viewing position. Such inference can be according to criteria such as; a user-state, context, and prior use of the terminal device. Accordingly, a display can be automatically configured to optimize its orientation for viewing by the user. The system can additionally provide for a holder that enables a user to employ the terminal device hands free for capture of data.

### CROSS REFERENCE TO RELATED APPLICATION

This application claims the benefit of U.S. provisional application 60/476,702 filed on Jun. 6, 2003.

### TECHNICAL FIELD

The present invention relates to a mobile scanning terminal device. More particularly, the invention relates to mobile scanning terminal device which provides for inversion and/or rotation of display based at least upon; a user perspective, bar code scanning and image capture requirements.

### BACKGROUND OF THE INVENTION

Retail establishments are trying to become more efficient by applying different and innovative operating methods and systems that help increase their business's financial condition.

One pursued goal is making product information readily available for a customer and/or an employee. Retail establishments contain a vast amount of merchandise, but with an inadequate means for informing customers and/or employees details of such merchandise. An evolution of retail establishments has caused replacement of manual price keying of each item, for the process of scanning the item in order to obtain information-on the merchandise. Today, bar code readers are commonly used in commercial and retail environments—bar code readers allow easy access to product information for both consumers and/or employees.

Another evolution in retail establishments has been use of portable bar code readers that are widely used in manufacturing, service and package delivery industries to perform a variety of on-site data collection activities. Such portable data collection devices often include integrated bar code dataform readers adapted to read bar code dataforms affixed to products, product packaging and/or containers in warehouses, retail stores, shipping terminals, and the like, for inventory control, tracking, production control and expediting, quality assurance and other purposes. Various bar code dataform readers can be employed for portable data collection devices including laser scanners and one dimensional (1D) charge coupled device (CCD) imaging assemblies, both of which are capable of reading 1D bar code dataforms and two dimensional (2D) bar code dataform.

Further evolution involves implementation of wearable portable bar code readers. Two major wearable computer (or portable data collection devices) form factors are belt/head-worn products that typically come equipped with a head-mounted display and headset microphone and/or tablet display, and wrist/finger-worn devices, that are usually associated with a bar code scanner and a voice or touch screen interface.

Such portable data collection devices are widely used in manufacturing, service, and package delivery industries to perform a variety of on-site data collection activities, including integrated bar code dataform readers adapted to read bar code dataforms affixed to products, product packaging and/or containers in warehouses, retail stores, shipping terminals, and the like, for inventory control, tracking, production control and expediting, quality assurance and a wide variety of other purposes.

A portable finger-worn scanning device called a “ring” scanner enhances data capture in environments by extending data collection capabilities beyond traditional parcel and baggage processing, warehouse order picking and inventory applications to grab data at any point of activity, e.g., indoor and outdoor environments such as scanning lift tickets at a ski slope, ticket scanning for concert and event admittance. . . .

One type of bar code reading system consists of a rack with portable scanning terminals. Price information for each item in the store is downloaded from the store's computer into the terminal's memory during a time when the system usage is low or the system is non-operational. Each customer and/or employee can utilize a scanning terminal upon placing their 1D or shopper loyalty card into a card reader (e.g., magnetic stripe reader or bar code reader) in the rack at a log-in station.

While shopping, the customer uses the terminal to scan bar codes associated with his purchases. The terminal generally has two scan trigger keys: the plus trigger key and the minus trigger key. Each trigger activates the scanning module located inside the terminal. When the consumer wishes to add a product to the group of items he wants to purchase, he uses the add trigger key to scan the product bar code. This process adds the item to the consumer's purchased item list inside the terminal's memory. In case the customer decides to return one of the items previously added to the purchased item list, he scans the item bar code using the minus trigger key. This process deletes the product from the customer's purchase item list inside the terminal's memory. In each case the information regarding the scanned item is displayed on the terminal screen. This information may include the price of the returned item as well as the quantity of the item on the customer's buy list.

An employee uses the terminal to scan bar codes for product information and/or stocking purposes. The terminal consists of a trigger which activates the scanning module located inside. Employees utilize portable bar code readers to facilitate price checking, product quantities, and/or shipping orders on a product. In either situation the information regarding the scanned item is displayed on the terminal screen.

However, terminal bar code readers do not provide information as readily and/or effectively as the current market demands. A consumer and/or employee typically scans a product and contort the bar code reader in order to view the display and information provided. The position utilized for scanning a product does not allow a user to view the display accurately and/or at all. The bar code reader is not effective based upon this constant contortion and/or adjustment between the modes of scanning a product and reading the display. In view of the above, there is a strong need for a mobile scanning terminal device and/or system that facilitates the readability of a display based upon the perspective of the user.

### SUMMARY OF THE INVENTION

The following presents a simplified summary of the invention in order to provide a basis understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention generally relates to modifying and/or configuring an application based at least upon a parameter of an operating environment. In accordance with an aspect of the invention, an application modifier system determines defining parameters of an operating environment. The application modifier system modifies and/or configures an application based at least upon the determined parameters. The application modifier system provides for modifying and/or configuring an application based at least upon one defining parameter of the operating environment. The application modifier system provides for determining a plurality of parameters for a plurality of operating environments.

The present invention provides a mobile scanning terminal system that facilitates scanning and viewing of data. The system provides for a mobile scanning terminal device with automatic display inversion and/or rotation capabilities. The mobile scanning terminal device provides for inverting and/or rotating the display based at least upon a user perspective. After a 180 degree rotation of the mobile scanning terminal device, the display can be automatically inverted and/or rotated in order to present the display appropriately (e.g., right-side up) to the user. The mobile scanning terminal device is not limited to inverting and/or rotating the display 180 degrees, but provides for inverting and/or rotating to any desired angle and/or orientation. In one aspect in accordance to the present invention, the mobile scanning terminal allows a user to collect data easily through “hands-free” presentation mode scanning, also allowing the same user to still use the mobile scanning terminal's display. For example, the mobile scanning terminal device provides for display inversion and/or rotation, in which the user can view the display regardless of device orientation.

Another aspect in accordance with the present invention is providing for a continuous scanning mode from the mobile scanning terminal device's display. The continuous mode scanning provides for the mobile scanning terminal to be used while placed in, or alternatively not placed into a holder. For example, when the mobile scanning terminal device is in a predetermined holding and/or mounted position, the display can provide inversion and/or rotation. In another example, the present invention provides for a screen option to return the mobile scanning terminal device to standard usage.

In another aspect in accordance with the present invention, the mobile scanning terminal device provides for an invert display option. The invert display option provides for inversion and/or rotating regardless if the mobile scanning terminal device is held and/or mounted. Another aspect of the present invention, the mobile scanning terminal device provides for a presentation-scanning holder and/or mount. The mobile scanning terminal device can be mounted upside down but utilize the inversion of the display to allow a user to view the display.

Additionally, the device provides for presentation-scanning while the device is contained in the presentation-scanning holder and/or mount. While in presentation-scanning, the present invention provides for scanning of data and/or display to user regardless of the mobile scanning terminal device orientation (e.g., upside down or right-side up).

In another aspect in accordance of the present invention, a secure and fast wireless data synchronization with a central location is provided. The central location can communicate to a host system, for example, via the Internet. The host system can provide a network in which the present invention can be implemented.

In accordance to an aspect of the present invention, a ring-type mobile scanning terminal device provides for the scanning of data and display manipulation based at least upon the orientation of a user. The ring-type mobile scanning terminal device can provide inverting and/or rotating the display based at least upon a user perspective.

Additionally, the mobile scanning terminal device provides for audio and/or voice recognition for feedback and/or input via, for example, a headset, and/or a microphone.

In another aspect in accordance to the present invention, the mobile scanning terminal device provides for image capture. The mobile scanning terminal device allows a user to capture images for analysis. Additionally, the mobile scanning terminal device provides for image capture corresponding to the inversion and/or rotation of the display.

To the accomplishment of the foregoing and related ends, the invention then, comprises the features hereinafter fully described and particularly pointed out in the claims. The following description and the annexed drawings set forth in detail certain illustrative aspects of the invention. These aspects are indicative, however, of but a few of the various ways in which the principles of the invention may be employed and the present invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

FIG. 1 is a diagram of a mobile scanning terminal system in accordance with an aspect of the present invention.

FIG. 1A is a diagram of a mobile scanning terminal device utilizing a hands-free environment in accordance with an aspect of the present invention.

FIG. 2 is a block diagram of a mobile scanning terminal system in accordance with an aspect of the present invention.

FIG. 3 is methodology of a mobile scanning terminal system in accordance with an aspect of the present invention.

FIG. 4 is a block diagram of a mobile scanning terminal system in accordance with an aspect of the present invention.

FIG. 5 is a block diagram of a mobile scanning terminal system in accordance with an aspect of the present invention.

FIG. 6 is a block diagram of a mobile scanning terminal system in accordance with an aspect of the present invention.

FIG. 7 is a diagram of a mobile scanning terminal system in accordance with an aspect of the present invention.

FIG. 8 is a block diagram of a mobile scanning terminal system in accordance with an aspect of the present invention.

FIG. 9 is a block diagram of a mobile scanning terminal system in accordance with an aspect of the present invention.

FIG. 10 is a block diagram of a portable data collection system in accordance with an aspect of the present invention.

FIG. 11 is a block diagram of a sample-computing environment in accordance with an aspect of the present invention.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers.

The present invention can employ various inference schemes and/or techniques in connection with filtering desirable analysis on a captured image. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject invention.

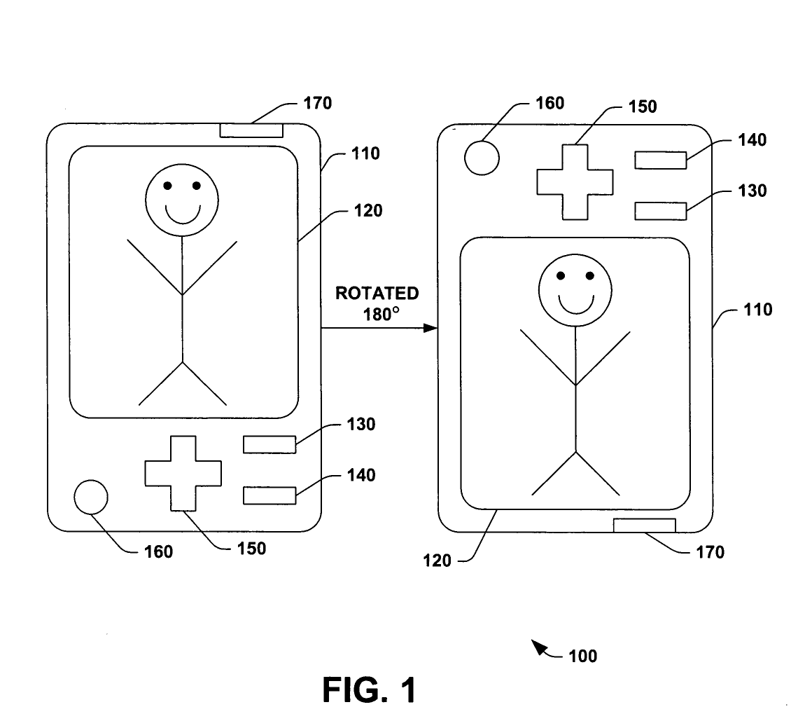

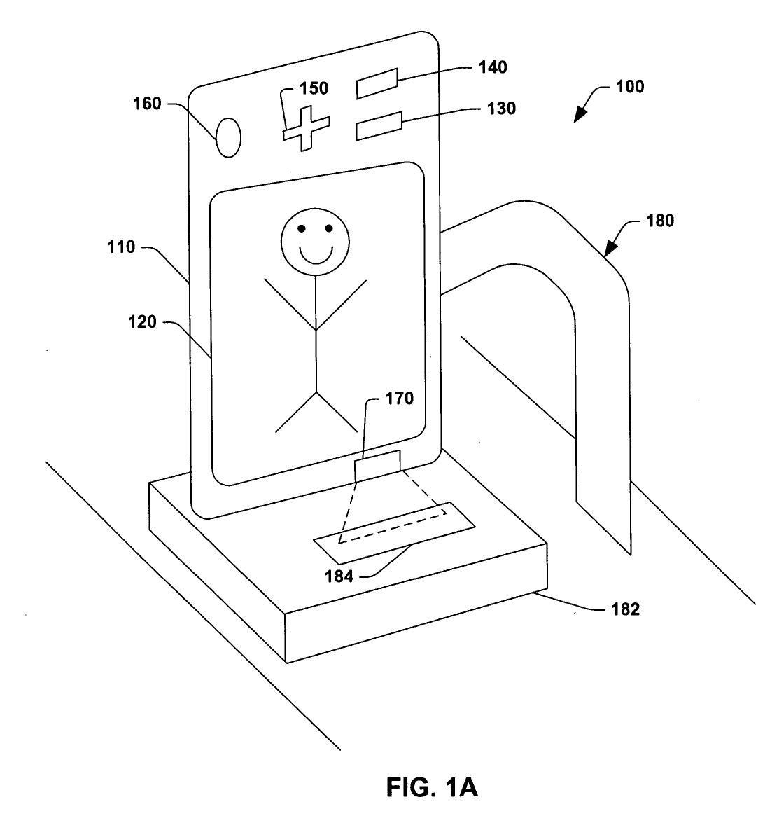

Now turning to the figures, FIG. 1 demonstrates a mobile scanning terminal system 100 for facilitating the scanning and viewing of data. Mobile scanning terminal system 100 comprises a mobile scanning terminal device 110 providing display inversion and/or rotation. The mobile scanning terminal device 110 includes a display 120, and provides for inverting and/or rotating the display 120 based at least upon a user perspective. After and/or during rotation of the mobile scanning terminal device 110, the display 120 can be concurrently inverted and/or rotated in order to present the display appropriately (e.g., right-side up) with respect to the user. The mobile scanning terminal device 110 is not limited to inverting and/or rotating the display 180 degrees, but provides for inverting and/or rotating from 0 degrees to any desired rotation angle. Thus, for example if a user lies on his/her side during a task, the display can be automatically configured to facilitate optimal viewing of the display relative to the user.

The mobile scanning terminal device 110 includes various controls 130, 140, 150, 160, and image capture component 170. The image capture component 170 provides for capturing an image, and can be part of the mobile scanning terminal device 110 or a separate component. The present example demonstrates the image capture component as part of the mobile scanning terminal device 110 but is not so limited. The controls 130, 140, 150, and 160 provide the user with the actions to control the mobile scanning terminal device 110. The present example consists of controls 130, 140, 150, and 160 but is not limited to such an embodiment. The mobile scanning terminal device 110 can have a plurality of controls 130, 140, 150, 160 or no controls 130, 140, 150, 160. In one example, control 130 can be a scan bar code action in which the scanning mobile terminal utilizes a scanning module to scan a bar code. In the same example, control 140 could be an image capture action. The control 140 provides the action of capturing an image via image capture component 170. Still referring to the example, control 150 provides the user with a directional pad to facilitate manipulation of data on the display 120. The directional pad can allow a user to scroll up and/or down, and/or left and/or right. The directional pad provides efficient access to information provided on display 120. In the same example, control 160 can be a power on/off action, in which the scanning mobile terminal device is powered on and/or off. The control 160 allows a user to conserve power when the mobile scanning terminal device is not in use. In one accordance with one aspect of the present invention, the mobile scanning terminal 110 allows a user to collect data easily via “hands-free” presentation mode scanning, also allowing the same user to continue utilizing the mobile scanning terminal's display 120. For example, the mobile scanning terminal device 110 can provide for display inversion and/or rotation, in which the user can view the display 120 regardless of device orientation.

Another aspect in accordance with the present invention is providing for a continuous scanning mode from the mobile scanning terminal device's scanner 170. The continuous mode scanning provides for the mobile scanning terminal to be used while not placed into a holder. For example, when a user detaches the mobile scanning terminal from a holding and/or mounted position (e.g., a shopping cart), the continuous scanning mode where the mobile scanning terminal device 110 display provides to invert and/or rotate based at least upon a user perspective is available. In other words, inversion and/or rotation can be effectuated regardless of whether the mobile scanning terminal device 110 is in a holding and/or mounted position. In another example, the present invention provides for a screen option to return the mobile scanning terminal device 110 to standard usage.

In another aspect in accordance with the present invention, the mobile scanning terminal device 110 provides for an invert display option. The invert display option enables inversion and/or rotating regardless of whether the mobile scanning terminal device 110 is held and/or mounted. For example, if a user prefers to use a mobile scanning terminal device 110 upside down rather than right-side up, the invert display option can be utilized. In another example, the present invention provides for a screen option to return the mobile scanning terminal device 110 to standard usage. It is to be appreciated that such option can provide for user-initiated re-configuration of the display to any suitable angle (0-360 degrees) as well as three-dimensional display orientation such that display objects can be rotated along more than one axis.

In accordance with another aspect of the present invention, the mobile scanning terminal device 110 provides for a presentation-scanning holder and/or mount. For example, the mobile scanning terminal device can be held and/or mounted to a shopping cart, in which a continuous, hands-free presentation mode scanning can occur. The mobile scanning terminal device 110 can be mounted upside-down but utilize the inversion of the display to allow a user to optimally view the display.

In another aspect of the present invention, the mobile scanning terminal device 110 facilitates scanning barcodes. For example, the barcodes can be scanned under the mobile scanning terminal device 110 for data collection and/or editing.

Additionally, the mobile scanning terminal device 110 provides for presentation-scanning while the mobile scanning terminal device 110 is contained in the presentation-scanning holder and/or mount. While in presentation-scanning, the present invention provides for scanning of data and/or display to a user regardless of the mobile scanning terminal device orientation (e.g., upside down or right-side up).

In another aspect of the present invention, a secure and fast wireless data synchronization with a central location is provided. The central location can communicate to a host system, for example, via the Internet. The host system can provide a network in which the present invention can be implemented. The network can implement a wired (e.g., electrically conductive or optical) or wireless (e.g., Bluetooth, cellular, . . . ) data communications protocol. Those skilled in the art will understand and appreciate various data communications protocols (e.g., TCP/IP, Ethernet, Asynchronous Transfer Mode (ATM), Fiber Distributed Data Interface (FDDI), Fiber Channel, and the like) that could be utilized to implement suitable data communications over the network in accordance with an aspect of the present invention. The host system can consist of a database, and/or server, and/or communication.

In accordance with an aspect of the present invention, a ring-type mobile scanning terminal device provides for the scanning of data and display manipulation based at least upon the orientation of a user. The ring-type mobile scanning terminal device can provide inverting and/or rotating the display based at least upon a user perspective. For example, the ring-type mobile scanning terminal device allows lightweight scanning utilizing a wired and/or wireless (e.g., Bluetooth) ring scanner. It is respected that all aspects of the current invention can be implemented with a ring-type mobile scanning terminal device and/or any other mobile scanning terminal device and is not limited to such examples.

Additionally, the mobile scanning terminal device 110 can provide for audio and/or voice recognition for feedback and/or input via, for example, a headset, and/or a microphone. Furthermore, the mobile scanning terminal device 110 can provide for image capturing, thereby enabling image analysis. For example, a user can capture, analyze, and/or determine product identity based at least in part upon an image of a damaged good. Once the damaged good is determined, the scanning mobile device can act (e.g., order new good, request guidance, inform manufacturer, . . . ) upon user and/or appointed authority (e.g., artificial intelligence technique). Additionally, the mobile scanning terminal device 110 can provide for image capture corresponding to the inversion and/or rotation of the display 120. For example, a user A can capture an image B while the mobile scanning terminal device is upside down (Note the user would see the display as right-side up based upon the display inversion and/or rotation). If such user A sends image B to another entity, the image B will be seen as right-side up, regardless of the orientation of the mobile scanning terminal device 110.

Referring briefly to FIG. 1A, an exemplary implementation of the mobile terminal scanning system 100 is illustrated. The mobile terminal scanning device 110 is restrained from movement by a holding mechanism 180, thereby facilitating hands-free scanning. For example, both of a user's hands can be utilized to quickly move products under the scanner 170. Alternatively, a conveyor belt can be provided to facilitate efficient scanning of multiple products. Voice commands or other sensing methods can be utilized to inform the scanning device 110 to perform a scan on a product 182. A conventional scanning device would display contents 180 degrees from optimal viewing position (e.g., contents of a display would appear upside down to a user). However, the scanning system 100 enables contents of the display 120 to be oriented in optimal viewing position to a user (e.g., top-to-bottom and left-to-right, such as reading a book).

The scanning device 110 scans a product 182 passing beneath the image capture component 170, which can be utilized to send and receive optical signals and determine information stored within a bar code 184. As the product 182 is scanned, information (e.g., images and/or text) is relayed to the display 120. The scanning device 110 can thereafter orient the information to facilitate placing the contents at an optimal viewing location (e.g., right-side-up), thereby enabling efficient relay of data from the scanning device 110 to the user.

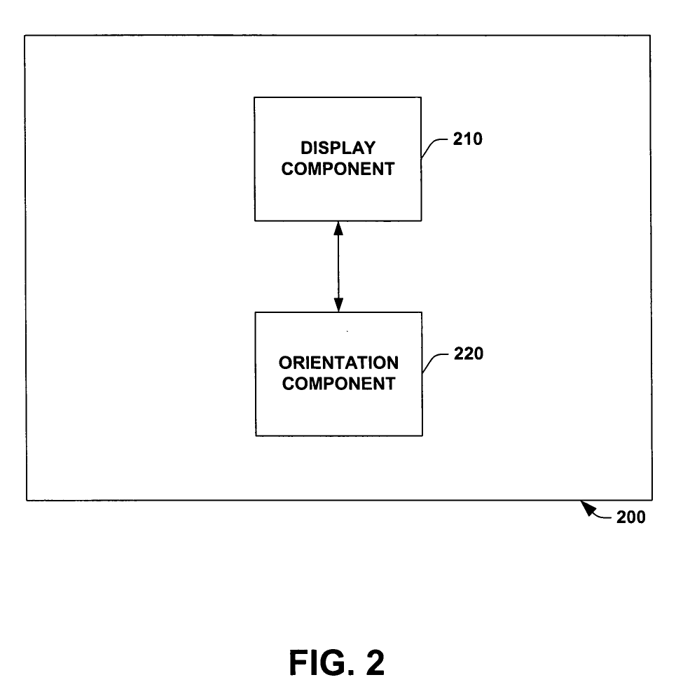

Referring now to FIG. 2, a high-level system overview in connection with one particular aspect of the subject invention is illustrated. A mobile scanning terminal system 200 facilitates displaying graphical image(s) and/or text at an optimal viewing orientation. Typically, displays are desirably viewed top-to-bottom and left-to-right (e.g., reading a book). Displays associated with hand-held bar code scanners, however, are oftentimes positioned to be unreadable in a conventional manner. For example, a circumstance can arise wherein a user is required to position a scanner angularly to a user sightline, resulting in difficult comprehension of contents displayed. Furthermore, typical mechanisms for retaining a hand-held device can cause the display to appear 180 degrees removed from optimal viewing position of a standing user (e.g., up-side-down).

The system 200 enables contents of such a display to be oriented according to optimal viewing position (e.g., contents appear top-to-bottom and left-to-right). The system 200 comprises a display component 210, such as a LCD, TFT, CRT, LED, flat-panel, plasma, and the like, and can render image and/or textual information and relay such information to a user. For example, graphical rendering of products and price, re-ordering information, and the like, can be displayed to a user. During an occurrence that the display component 210 is angularly displaced, an orientation component 220 can manipulate the images and/or text within the display component 210 to desirably orient such images and/or text. The orientation component 220 can employ various sensors as well as artificial intelligence techniques to determine appropriate orientation of the images and/or text within the display component 210.

In accordance with one aspect of the present invention, a hand-held bar-code scanner can be positioned in a retaining device that renders the display component 210 180 degrees from optimal viewing position. Such an arrangement can be beneficial in circumstances that hands-free scanning is desired (e.g., rapid scanning can occur utilizing a conveyor belt and voice-command scanning). The orientation component 220 can thereafter automatically invert the images and/or text desirably viewed by a user, thereby enabling such user to quickly comprehend information relayed from the display component 210. While in the aforementioned example the angular displacement of the display component 210 was 180 degrees, it is to be understood that the orientation component 220 can rotate images and/or text to a desirable viewing position when any angular displacement of the display component 210 exists.

In accordance with an aspect of the present invention, the mobile scanning terminal system 200 can be employed to facilitate hierarchical traversing through a store and/or product via graphically representing such store and/or product. For example, a graphical representation of various store locations can be rendered utilizing the system 200. Upon selection of a particular store location via keystrokes, touch screen, voice command, etc., product areas, aisles, etc. can be displayed (e.g., food aisle, clothing aisle, and the like.) A desired product area can be selected, resulting in display and/or listing of products in such location. Graphical displays can continually be generated until a desirable level within the hierarchy is reached, or alternatively, until single product information and/or display is achieved. Information relating to such store, product location, etc. can thereby be quickly and efficiently received by a user. For instance, in an occurrence of a price check in a grocery store, a user can quickly navigate through the hierarchy to obtain such price, product location, number of available products, scheduled restocking data, etc. Furthermore, because the system 200 comprises and/or can access such data, upon scanning a product desirable information can be obtained (e.g., product location, price, and the like).

In accordance with another aspect of the present invention, the system 200 can determine whether a particular product resides in a proper location via scanning a bar code. For example, products shelved during stocking are desirably placed in a proper location to effectively enable efficient shopping. A user can scan a bar code relating to product location and store results of the scan. Thereafter particular products desirably placed within the selected product location are scanned, and utilizing such information via scanning the product location and particular product, a determination of whether the product is being placed in the proper product location is made. Upon determining that the product should not be in such product location, the system 200 can inform the user that the product is misplaced, and relay to the user a correct product location for such product. Moreover, upon scanning all products in a particular product location, the system 200 can automatically generate re-order forms and transmit such forms to a manufacturer if no previous order exists and the number of products at the product location is below a threshold. Alternatively, re-order forms can be transmitted to a printing device, thereby enabling re-order form review before delivery to the manufacturer.

In accordance with another aspect of the present invention, the system 200 can be employed to generate re-order forms via voice commands. For example, a series of images and/or text can be displayed, and simple one-word responses can be utilized to navigate store hierarchy until a desirable level of the hierarchy is reached (e.g., a product). Product information can be displayed, and a user can issue voice commands to re-ordering such product if appropriate. Alternatively, the user can state a product name or identification, and the system 100 can display re-ordering information.

In accordance with another aspect of the present invention, the system 200 can display ordering history upon scanning of a product. Furthermore, a product location can be scanned and history of product(s) within such product location can be displayed to a user. Reordering history enables users to quickly ascertain rate of product sales based upon number of products ordered and number of re-orders within a particular time period. Moreover, the system 200 can connect to a product provider to determine arrival of shipments. For instance, upon scan or selection (e.g., voice commands, navigation through hierarchy, image recognition . . . ) of a product, shipping schedule related to such product can be displayed to a user. Such shipping information facilitates efficient retrieval and/or display of products within a store (e.g., trucks will not be deployed to pick up products if they are unavailable, and products can be displayed without delay upon arrival to the store). Moreover, instances of lost shipments can be quickly realized.

In accordance with yet another aspect of the present invention, the system 200 can poll product availability to determine whether re-ordering is appropriate. If a number of a particular product within a store is found to be below a threshold, the number of products remaining and re-ordering history can be displayed to a user. The user can thereafter determine whether re-ordering such product is appropriate. Alternatively, artificial intelligence techniques can be employed for automatically re-ordering products based upon past sales, future projections, and other extrinsic data. Furthermore, re-ordering history information (e.g., number of sales, number of re-orders, and the like) can be utilized to generate sales trend information, such as graphs and charts. Such information can then be relayed, either automatically or via user command, to a display, other stores in a chain, managers, owners, etc.

In accordance with yet another aspect of the present invention, the system 200 can act as a data reception/transmission device, wherein emails, news bulletins, voice mail, and other similar communication can be received and/or transmitted. For instance, a user scanning items in one section of a store can desirably speak to a manager located in another section of the store. The system 200 can act as a communication means to contact such manager without requiring the user to locate the manager (e.g., the system 200 can be a phone, two-way radio, internet module, and the like). Furthermore, information pertinent to the user can be immediately ascertained via transmitting such information to the system 200.

The present invention also enables surveys and training information to be displayed. Surveys are important for ensuring employees and/or customer satisfaction, as well as remaining knowledgeable regarding public opinion on issues relating to a store, market data, competitive information, etc. Training information for new employees and/or employees assigned a task with which they are unfamiliar facilitates efficient store operation, and also enlarges storage space and reduces overhead (e.g., televisions, VCRs, DVD players, video tapes, personal computer and the like are not required for training employees).

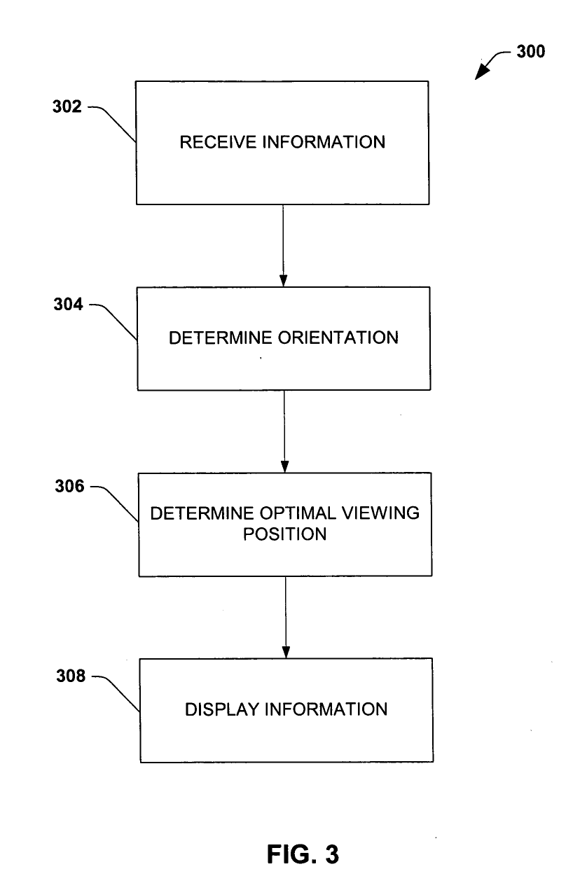

Turning now to FIG. 3, a methodology 300 for generating an optical viewing position of images and/or text within a mobile terminal scanning system display is illustrated. While, for purposes of simplicity of explanation, the methodology is shown and described as a series of acts, it is to be understood and appreciated that the present invention is not limited by the order of acts, as some acts may, in accordance with the present invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

At 302, information (images and/or text) desirably displayed on a mobile terminal scanning system display is received. The information can be received upon user navigation through store and product hierarchy, a bar code scan, photographing a product, voice commands, reception of messages, etc. Graphical representations and/or text relating to entities such as but not limited to products, product locations, store locations, and/or maps can be stored in a memory and received upon scanning a bar code, user selection, and/or artificial intelligence techniques can be employed in connection with reception of such entities. Furthermore, information can be received from an external application via cables, Ethernet, wireless communication, etc. Moreover, photographs can also be received for display from an internal image-capturing device.

At 304, orientation of a display facilitating relay of such information to a user is determined. Sensors can be employed to determine angular displacement from typical optical viewing location (e.g., whether images and/or text are displayed parallel to ground). At 306, optical viewing position can be determined via employing various sensors and artificial intelligence techniques to infer such position according to user-state, context, and previous use. For example, a user viewing the display horizontally will not desire the same viewing position as a user viewing the display vertically. Inferences can be made thereby enabling optimal viewing position of a display for a particular user. Furthermore, sensors can operate in connection with artificial intelligence techniques to display images and/or text at desirable size and/or resolution. For instance, a particular user can typically view a display from different distances during disparate times of a day. The methodology 300 can be implemented to facilitate optimal display position, image and/or text size, and resolution of the display.

At 308 the information is displayed at an optimal viewing position. Furthermore, image and/or text size as well as screen resolution can be manipulated to provide for a best possible display for a particular user. The display can be LCD, CRT, TFT, flat-panel, plasma, or any other suitable display type, and can be in color or grayscale. In accordance with one aspect of the present invention, contents of the display include information relating to a bar code scan. Furthermore, the videos can be relayed to a user via the display screen, and the videos will be oriented on such display in an optimal viewing position.

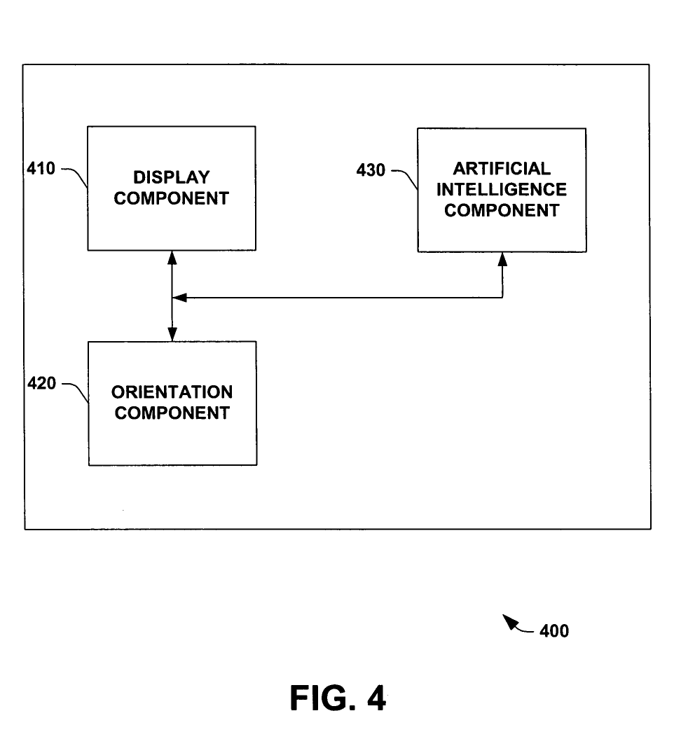

Turning now to FIG. 4, a mobile scanning terminal system 400 facilitating desirable orientation of images within a graphical display is illustrated in accordance with one aspect of the subject invention. The system 400 comprises a display component 410 for relaying images and/or text to a user. While general use of the system 400 is for bar-code scanning, the display component 410 can be employed to display any type of image and/or text (e.g., photographs, web pages, e-books, charts, news, and the like). When the display component 410 is angularly displaced from an optical viewing position, an orientation component 420 compensates for such angular displacement via rotating images and/or text thereby facilitating constant display at optical viewing position.

The system 400 further comprises an artificial intelligence component 430, wherein artificial intelligence techniques are utilized to provide optimum viewing position of images and/or text within display component 410 given a particular user state and context. The artificial intelligence component 430 can learn particular user preferences via monitoring past user actions and present user states. For example, a particular user can desirably view images and/or text within the display component 410 at angles disparate from typical optimal display angles (e.g., a user typically lying on a side of their body will desire a different display position than a user standing straight). The artificial intelligence component 430 can infer a desirable display angle for particular users and relay such information to the orientation component 420. Furthermore, the artificial intelligence component can render images and/or text of appropriate size, resolution, color, etc. to create optimized image and/or text display as well as an optimized viewing position.

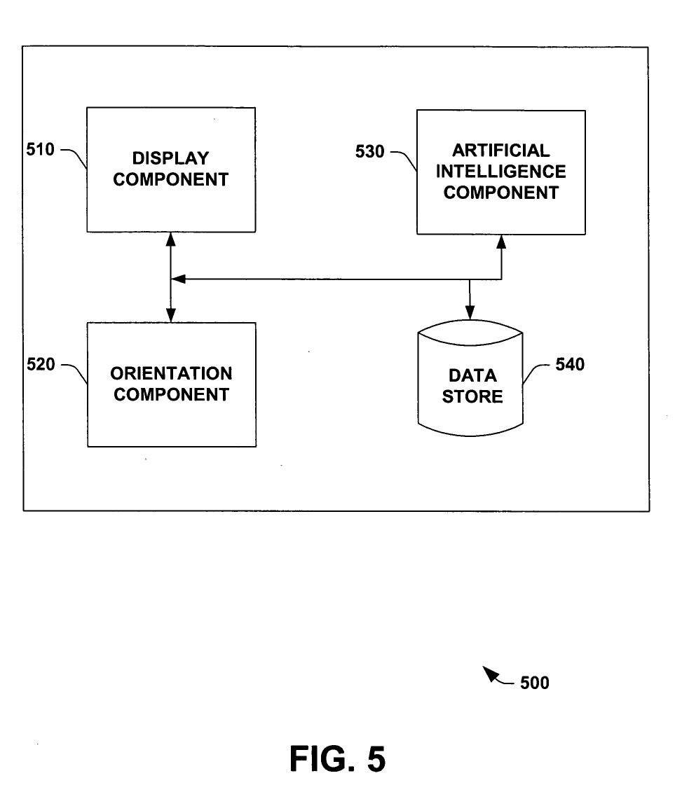

Turning now to FIG. 5, a mobile scanning terminal system 500 facilitating desirable orientation of images within a graphical display is illustrated in accordance with one aspect of the present invention. The system 500 comprises a display component 510 for displaying images and/or text to a user. An orientation component 520 facilitates adjusting a location of the images and/or text within the display component 510 to a desirable viewing position. An artificial intelligence component 530 facilitates customizing a viewing position according to a particular user state and context. The system 500 further comprises a data store 540 for storing historical data relating to scanned products, object images for display via the display component 510, visual identification arrays, etc. For example, upon scanning a particular object, the data store 540 can include a picture of such object and relay the picture to the display component 510.

Furthermore, the data store 540 can comprise past ordering data regarding such scanned object (e.g., dates of previous orders, number of products included within each order, trends, market share of such product, manufacturing information, . . . ). Moreover, the system 500 can include a photographing device (not shown), and the data store 540 can comprise arrays facilitating visual recognition of products photographed by such photographing device. For example, a photograph can be taken of a particular product, and the data store 540 can include image recognition arrays to identify such photographed product. Thereafter information pertaining to such photographed product can be displayed to a user, and in accordance with one aspect of the present invention, automatic re-ordering can occur if a number of the products available is below a threshold. Moreover, damaged products can be recognized and such photograph can be relayed to the manufacturer to facilitate reimbursement and/or replacement.

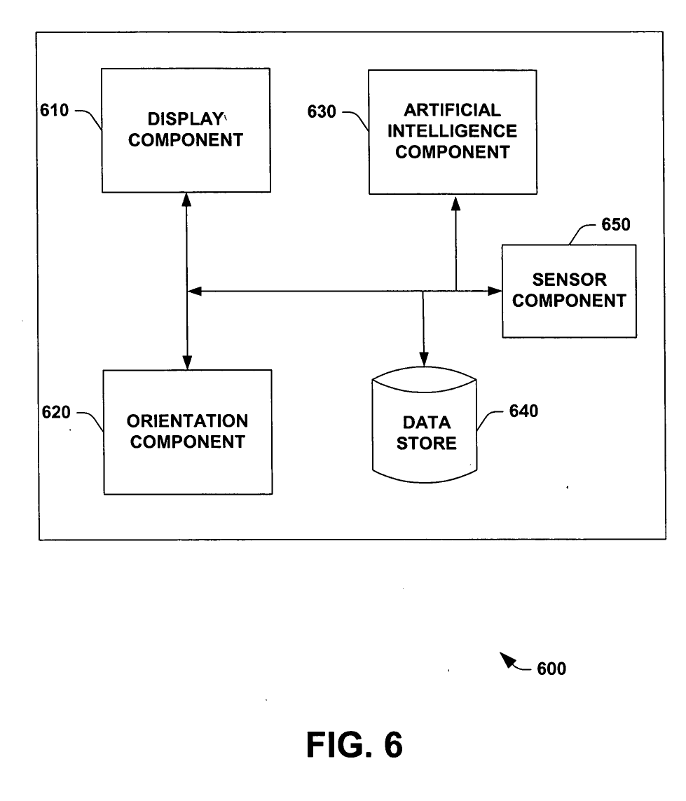

Now regarding FIG. 6, a mobile scanning terminal system 600 facilitating desirable orientation of images within a graphical display is illustrated in accordance with an aspect of the present invention. The system 600 includes a display component 610 for relaying images and/or text to a user. An orientation component 620 can be employed to enable the images and/or text displayed to a user to be in an optimal viewing position. An artificial intelligence component 630 can be provided to enable optimal image and/or text display based on user state and/or context. For example, a user typically viewing the display component 620 while lying on their side will desire a disparate display position compared to a user generally standing. The system 600 further comprises a data store 640 for retaining data relevant to products being scanned (e.g., photographs of products, product ordering history, visual identification arrays, and the like).

A sensor component 650 can be provided to operate conjunctively with the orientation component 620 and the artificial intelligence component 630 to enable optimized viewing position of images and/or text displayed within the display component 610. For example, the sensor component 650 can determine a distance between the display component 610 and a user, and appropriate image and/or text size, screen resolution, color, brightness, etc. can be displayed via the display component 610. Furthermore, the sensor component 650 can determine precise orientation between user sightline and the display component 610, and then relay such orientation to the orientation component 620.

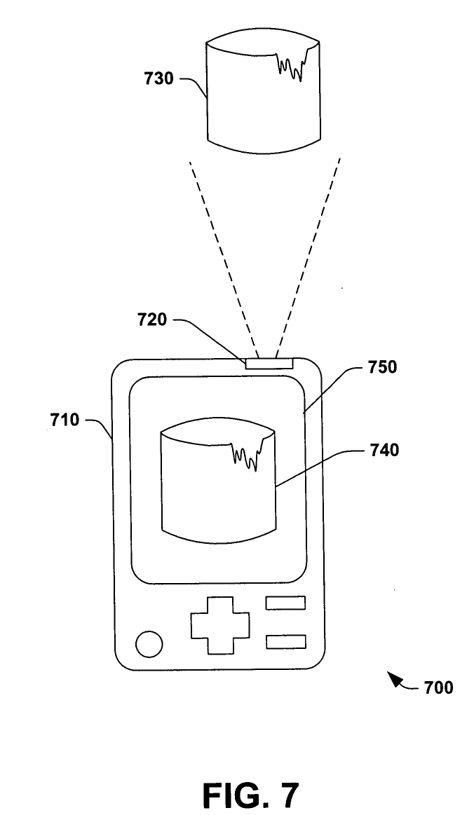

Turning to FIG. 7, a mobile scanning terminal system 700 is shown consisting of a mobile scanning terminal device 710 and a damaged merchandise 730. The mobile scanning terminal device 710 consists of a display 750, which can be inverted and/or rotated based at least upon a user perspective. After a 180 degree rotation of the mobile scanning terminal device 710, the display 750 is inverted and/or rotated in order to present the display appropriately (e.g., right-side up) to the user. The mobile scanning terminal device 710 is not limited to inverting and/or rotating the display 180 degrees, but provides for inverting and/or rotating from 0 degrees to N degrees, where N is an integer greater than 0. The mobile scanning terminal device 710 provides for image capturing via, for example, an image capturing component 720. The image capturing component 720 is shown, but not limited to, being part of the mobile scanning terminal device 710. The image capturing component 720 provides for image capture based at least upon user action. For example, the user can capture an image via the mobile scanning terminal device by directing the image capturing component to the said image (e.g., the damaged merchandise 730). The mobile scanning terminal device 710 provides for capturing an image (e.g., the damaged merchandise 730) and displaying the image to a user. For example, an image of the damaged merchandise 730 is captured, as seen at 740, via the image capturing component 720 and displayed to the user on the display screen 750.

In yet another example, a user can capture an image of a damaged merchandise 730, and thereafter such image can be analyzed and determined. Once the damaged merchandise 730 is determined (e.g., type, make, brand), the scanning mobile device can act (e.g., order new good, request guidance, inform others) upon user and/or appointed authority (e.g., artificial intelligence technique). Additionally, the mobile scanning terminal device 710 provides for image capture corresponding to the inversion and/or rotation of the display 750. For example, a user A can capture an image B while the mobile scanning terminal device 710 is upside down (Note the user would see the display as right-side up based upon the display inversion and/or rotation). If such user A sends image B to another entity, the image B will be seen as right-side up, regardless of the orientation of the mobile scanning terminal device 710.

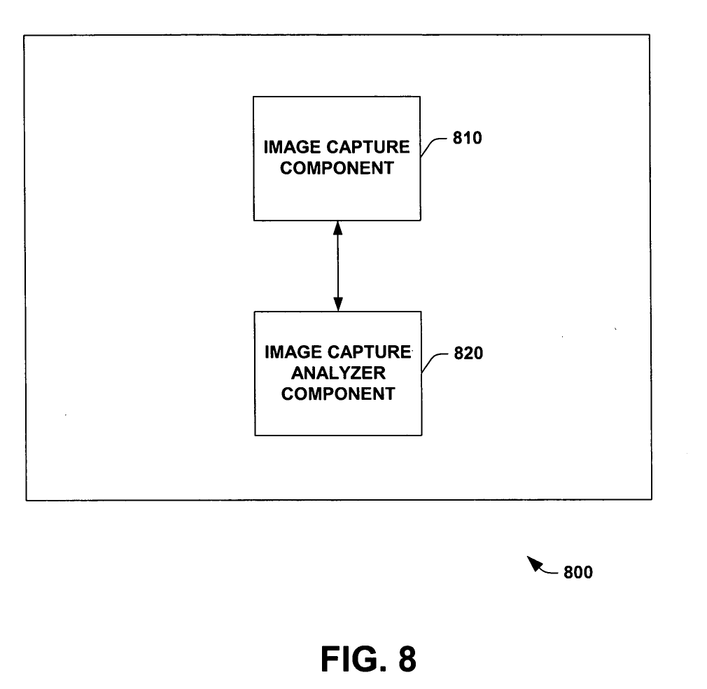

Referring to FIG. 8, a mobile scanning terminal system 800 is depicted consisting of an image capture component 810 and an image capture analyzer component 820. The image capture component 810 provides for capturing an image based at least upon a user selection. Data capture component 810 can be, but is not limited to; a digital camera, combination image capture and bar cod reader, camera, web-cam, and/or digital video camera. The image capture analyzer component 820 allows the image captured to be analyzed. The image capture analyzer component 820 can be based at least upon user-defined parameters. For example, a user can determine the types, kinds, and makes of merchandise within a system. Once an image is captured via image capture component 810, the analysis via the image capture analyzer component 820 can be based, at least in part on the user-defined merchandise.

In accordance with another aspect of the present invention, the image capture analyzer component 820 can operate within a wireless network (not shown) to optimally recognize and analyze images desirably captured. The wireless network can facilitate determining location and/or orientation of the image capture component 810 within a store. As location of products within a store is typically known, location and/or orientation of the image-capturing component can be utilized to determine captured product identity. For example, in an instance that the image capture component 810 is directed at a product location containing wine glasses, the image capture analyzer 820 can infer that an image captured in such a location is a wine glass (rather than, for example, a champagne glass).

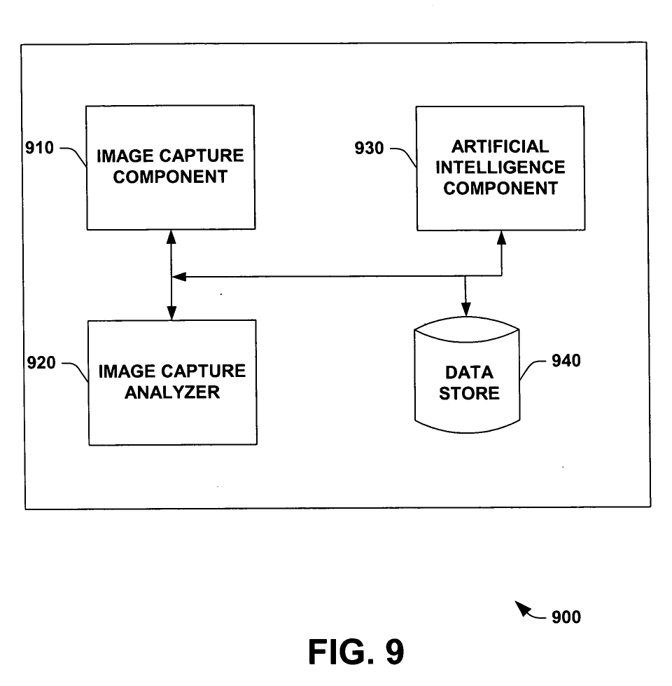

Turning to FIG. 9, a mobile scanning terminal system 900 contains an image capture component 910, an image capture analyzer 920, an artificial intelligence component 930, and a data store 940. The image capture component 910 provides for capturing an image based at least upon a user selection. Data capture component 910 can be, but not limited to a digital camera, camera, web-cam, and/or digital video camera. The image capture analyzer component 920 allows the image captured to be analyzed. The image capture analyzer component 920 can be based at least upon a user-defined parameters.

The mobile scanning terminal system 900 can utilize an artificial intelligence component 930 in which such artificial intelligent techniques (e.g., Bayesian learning methods that perform analysis over alternative dependent structures and apply a score, Bayesian classifiers and other statistical classifiers, including decision tree learning methods, support vector machines, linear and non-linear regression and/or neural network representation) infer analysis of the image captured. For example, the artificial intelligence component 930 can infer the image captured based at least upon a user profile. The artificial intelligence component 930 provides techniques to infer the typical images captured by an individual user. In another example, the artificial intelligence component 930 provides for determining an image captured based at least upon user-defined parameters.

The data store 940 facilitates storage of captured images, history records, and/or user profiles. For example, the data store 940 can be computer readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the present invention. In one example, the data store 940 can contain a user profile, in which a user defines parameters of captured images. In another example, the data store 940 can contain interrogation questions to be utilized in the analysis of determining the image captured. In yet another example, the data store 940 can contain merchandise surplus information to facilitate the ordering and/or shipping of merchandise.

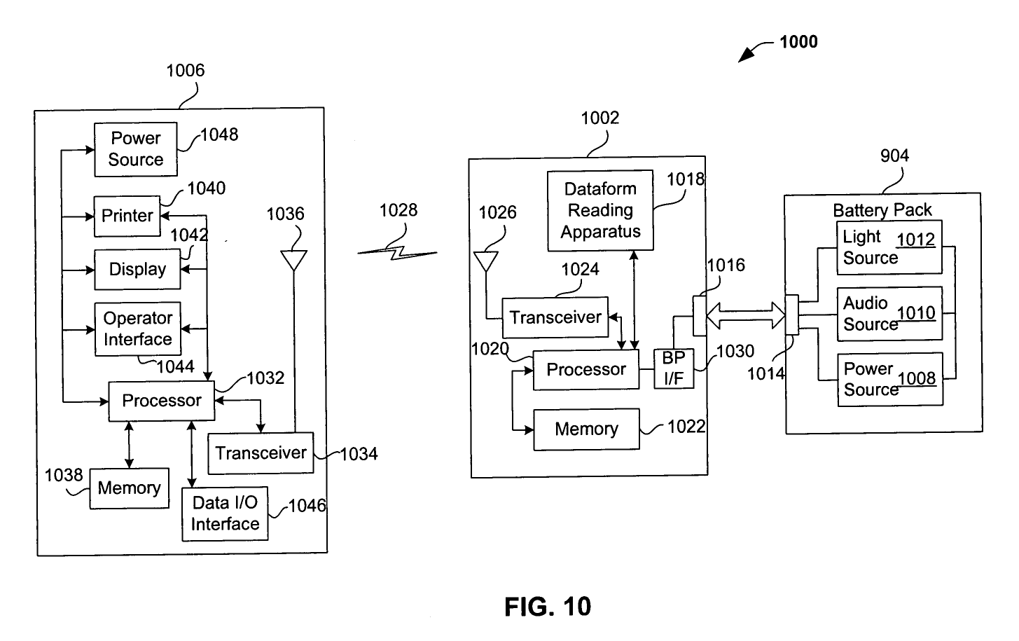

Referring now to FIG. 10, there is illustrated a system block diagram of a portable data collection system 1000. The system 1000 comprises a scanner 1002 in which a battery pack 1004 is engaged, and a remote collection unit 1006. The pack 1004 includes a power source 1008, audio source 1010 and light source 1012, all of which are operably interconnected with the scanner 1002 to provide power thereto and receive control signals therefrom. The pack 1004 interfaces to the scanner 1002 via an interface connector 1014 and a mating connector 1016 of the scanner 1002. Internal to the scanner 1002 are the communication and control circuits implemented for operation of the scanner 1002, and a reading apparatus 1018 necessary for reading a dataform.

The dataform reading apparatus 1018 may be any reading mechanism type utilized for reading data in a compatible format. For example, the reading apparatus may be a magnetic strip reader for reading a card or object containing a magnetically encoded strip dataform; a laser bar code scanner for reflecting a light beam from an encoded dataform to a image reading head; a card reader that receives a card with memory into a slot from which data can be read or input; a radio frequency (RF) system that transmits a pulse to card containing a passive transponder for reading the data contained therein (commonly found at toll gates, as the vehicle passes through the gate a transponder located within the vehicle is activated to read data unique to the owner), etc.

The communication and control circuits contained in the scanner 1002 comprise a processor 1020 for controlling all onboard functions of the scanner 1002 and image analysis for decoding the target dataform. A processor 1020 connects to the reading apparatus 1018 to activate the readings functions and call the data therefrom. Connected to the processor 1020 is a non-volatile memory 1022 that serves to store the various programs and other data associated with the operation of the scanner 1002. A communication transceiver 1024 connects to the processor 1020 for communicating data and signals between the scanner 1002 and the remote collection unit 1006. In this particular embodiment, the communication technology is RF. Thus an antenna 1026 connects to the transceiver 1024 to facilitate RF communication of signals and data wirelessly over the wireless link 1028 established between the remote collection unit 1006 and scanner 1002. Note that other wireless communication technologies can be utilized between the scanner 1002 and remote collection unit 1006, e.g., infrared. Further, the system can be implemented in a wired regime such that the scanner 1002 and remote collection unit are connected in wired communication.

The scanner 1002 also includes a battery pack power interface block (denoted “BP I/F”) 1030 for providing regulated power to the scanner circuits of power received from the power source 1008. The interface block 1030 also accommodates control signals from the processor 1020 to the light source 1012 and audio source 1010 of the pack 1004 for activating elements of the light source 1012 and the audio source 1010. Of course, any of the illustrated communication and control circuit blocks could be combined into fewer blocks or a single block as is typically implemented in an ASIC (Application Specific Integrated Circuit). A person having ordinary skill in the art will be able to program such operations of the scanner 1002 without undue effort. Hence, additional detail is not required.

The remote collection unit 1006 includes circuits compatible for communicating both data and signals to the scanner 1002. A unit processor 1032 controls all onboard operations, and connects to a transceiver 1034 for transmitting and receiving both signals and data of the scanner 1002. In support thereof, this RF implementation includes a unit antenna 1036 connected to the transceiver 1034. A unit memory 1038 connects to the processor 1032 and serves to store the various programs and other data associated with the operation of the collection unit 1006. A printer 1040 can also be incorporated for providing a record output of data and other information from the collection unit 1006. The processor 1032 connects thereto to provide the information and control signals for operation of the printer 1040.

A display 1042 is provided in communication with the processor 1032 to present data or other information relating to ordinary operation of the unit 1006 to the user. For example, the display 1042 may display a set of customer information, which is displayed to the operator and may be transmitted therefrom. Additionally, the display 1042 may display a variety of functions that control the execution of the collection unit 1006. The display 1042 is capable of displaying both alphanumeric and graphical characters. The display 1042 may be a liquid crystal display (LCD) or the like, so long as power consumption is relatively low. In more robust implementations, the display 1042 is a touch display that facilitates user input. Otherwise, there is provided an operator interface 1044 via which the operator enters input, e.g., a key pad, mouse pointer . . . . The collection unit 1006 also includes a data I/O interface 1046 via which data stored in the memory 1038 can be downloaded and/or signals communicated to the processor 1032. The data interface 1046 can include conventional interfaces such as USB (Universal Serial Bus), IEEE 1394, RS-232, etc. All power for the collection unit 1006 is provided by a unit power source 1048, which would typically be batteries, since the unit 1006 is worn on the operator. Power for the transceiver 1034, memory 1038 and data interface 1046 can be provided through the processor 1032, whereas the other circuits and peripherals can receive power directly from the power source 1048. Such power distribution methodologies to onboard circuits and peripherals are commonly known by one skilled in the art. To conserve power, the collection unit 1006 is operable to enter a minimum current draw of sleep mode when not in use.

Note that the processor 1020 can be configured to control operation of the reading apparatus 1018 while data and/or signals are being communicated between the remote collection unit 1006 and the processor 1020 from a previous read operation.

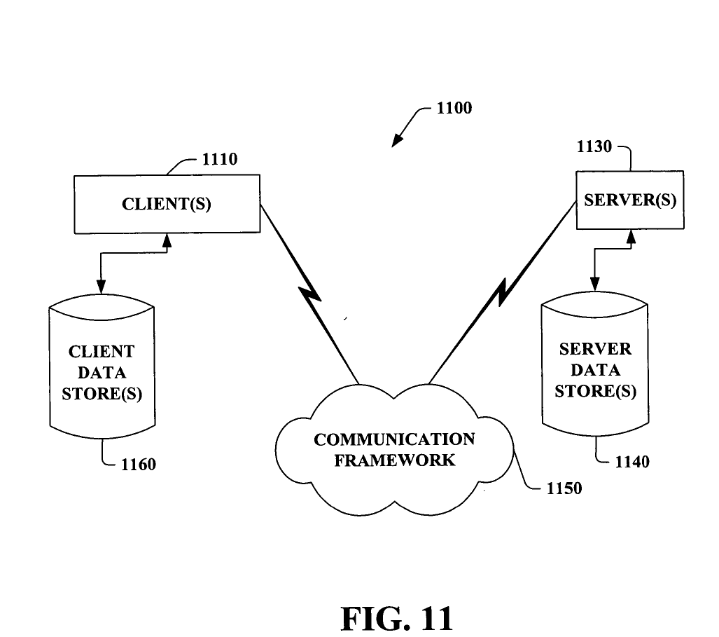

FIG. 11 is a schematic block diagram of a sample-computing environment 1100 with which the present invention can interact. The system 1100 includes one or more client(s) 1110. The client(s) 1110 can be hardware and/or software (e.g., threads, processes, computing devices). The system 1100 also includes one or more server(s) 1130. The server(s) 1130 can also be hardware and/or software (e.g., threads, processes, computing devices). The servers 1130 can house threads to perform transformations by employing the present invention, for example. One possible communication between a client 1110 and a server 1130 may be in the form of a data packet adapted to be transmitted between two or more computer processes. The system 1100 includes a communication framework 1150 that can be employed to facilitate communications between the client(s) 1110 and the server(s) 1130. The client(s) 1110 are operably connected to one or more client data store(s) 1160 that can be employed to store information local to the client(s) 1110. Similarly, the server(s) 1130 are operably connected to one or more server data store(s) 1140 that can be employed to store information local to the servers 1130.

What is claimed is:

1. A mobile device, comprising:
a display component; and
an orientation component that automatically orients display objects rendered by the display based at least in part upon a user perspective.

2. The mobile device of claim 1, further comprising an artificial intelligence component that infers a desired orientation for the display based at least in part upon a user context or state.

3. The mobile device of claim 1, further comprising a data store that stores product information.

4. The mobile device of claim 1, further comprising a bar code scanner.

5. The mobile device of claim 1, the orientation component further comprising a sensor component that determines respective location of a user.

6. The mobile device of claim 5, the sensor component comprising a gyroscope.

7. The mobile device of claim 1, further comprising a wireless component.

8. The mobile device of claim 1, further comprising an image capture component.

9. The mobile device of claim 8, further comprising an analysis component that analyzes image(s) captured.

10. The mobile device of claim 9, further comprising an artificial intelligence component that infers properties of the image.

11. The mobile device of claim 10, the analysis component identifies a product associated with the image.

12. The mobile device of claim 11, the analysis component identifies a product location associated with the image.

13. A method that facilitates displaying objects, comprising:
displaying graphical objects on a portable bar code scanning device; and
automatically orientating rendered graphical objects based at least in part upon a physical orientation of a user with respect to the device.

14. The method of claim 12, further comprising inferring user desired orientation of the display objects.

15. A mobile scanning terminal method, comprising:
displaying graphical objects;
automatically orientating the graphical objects based at least upon a user perspective; and
capturing an image for further analysis.

16. A mobile scanning terminal system, comprising:
means for displaying graphical objects; and
means for determining user desired orientation for rendering the objects.

17. A mobile scanning terminal system, comprising:
a data capture component that captures data;
a display that displays data to a user;
an artificial intelligence component that determines an optimal screen orientation for the display based at least upon a user's position; and
a holder that holds the data capture component at a predetermined position to allow for a hands-free capture of data.
